(19) United States
(12) Patent Application Publication
(10) Pub. No.: US 2022/0415209 A1
(43) Pub. Date: Dec. 29, 2022

(54) PERMANENT MAGNET GENERATOR EXPERIMENTAL DEVICE FOR SIMULATING ELECTROMECHANICAL CROSS AND COMPLEX FAULTS

(71) Applicant: North China Electric Power University (Baoding), Baoding (CN)

(72) Inventors: Guiji TANG, Baoding (CN); Mingxing XU, Baoding (CN); Yuling HE, Baoding (CN); Chenkai SUN, Baoding (CN); Wen ZHANG, Baoding (CN); Xiaolong WANG, Baoding (CN)

(21) Appl. No.: 17/356,665

(22) Filed: Jun. 24, 2021

(51) Int. Cl. G09B 23/18

(52) U.S. Cl. CPC G09B 23/188

(57) ABSTRACT

A permanent magnet generator experimental device for simulating electromechanical cross and complex faults is disclosed. The device includes a base, a DC drive motor, a permanent magnet simulation generator, bearing seats, a stator short circuit wiring board and time relays. A certain degree of radial air-gap eccentricity is set by moving a stator and a stator winding, and then a stator short circuit is set by controlling time relays; or a certain degree of axial air-gap eccentricity is set by moving a stator and a stator winding, and then a stator short circuit is set by controlling time relays. According to the above settings, different degrees of electromechanical cross and complex faults are simulated as required. The present invention is reliable in solution and easy to realize, and can simulate different degrees of radial air-gap eccentricity faults, axial air-gap eccentricity faults, stator short circuit faults, and compound faults of air-gap eccentricity and stator short circuit of a generator and provide the possibility of research and experimental analysis of air-gap eccentricity faults, stator short circuit faults, and compound faults of air-gap eccentricity and stator short circuit.

### TECHNICAL FIELD

The present invention relates to the technical field of simulation of electromechanical cross and complex faults, and more particularly relates to a permanent magnet generator experimental device for simulating electromechanical cross and complex faults.

### BACKGROUND

Generator air-gap eccentricity, as a common mechanical fault, refers to a phenomenon that the stator-to-rotor air gap is not distributed symmetrically and is more on one side and less on the other side, for example, rotor displacement and stator core thermal deformation will cause air-gap eccentricity faults. At present, air-gap eccentricity usually refers to radial air-gap eccentricity which is static eccentricity, and the maximum and minimum stator-to-rotor air-gap positions will not change with the operation of the generator. In most cases, a generating set has axial air-gap asymmetry, i.e., axial air-gap eccentricity, in addition to radial air-gap asymmetry. For example, the rotor has an axial offset due to poor operating condition of the generator and other reasons, which causes the air gap of the effective cutting area of a stator-to-rotor magnetic induction line to be more on one side and less on the other side, thus resulting in axial air-gap eccentricity.

Air-gap eccentricity faults will cause the generator field to change, and result in intensified stator-rotor vibration and hazards such as stator core deformation, winding abrasion and insulation breakdown, and short circuit faults are easy to occur after winding insulation abrasion.

A stator short circuit is a common electrical fault which can be classified into a stator interturn short circuit fault and a stator interphase short circuit fault. As the internal rotor of a permanent magnet generator is a separate permanent magnet, no rotor short circuit fault exists. If the generating set operates with faults, further development may cause ground faults and even irreparable damage to the generating set.

Most of researches on permanent magnet generators at the present stage are specific to single air-gap eccentricity faults or single stator short circuit faults. Few experimental devices which can simultaneously simulate air-gap eccentricity faults and stator short circuit faults.

Therefore, the problem to be urgently solved by those skilled in the art is how to provide an experimental device capable of simulating electromechanical cross and complex faults.

### SUMMARY

In view of this, the purpose of the present invention is to provide a permanent magnet generator experimental device for simulating electromechanical cross and complex faults, which can simulate electromechanical cross and complex faults.

The permanent magnet generator experimental device for simulating electromechanical cross and complex faults provided by the present invention comprises:

A base, having a rectangular steel plate structure;

A DC drive motor, fixed on the base;

A permanent magnet simulation generator, comprising a stator, a permanent magnet rotor and a stator fixed seat, wherein the stator fixed seat and the DC drive motor are arranged in parallel on the base; the stator is fixed in the stator fixed seat; and the permanent magnet rotor is supported on the base through two bearing seats, the rotating shaft of the permanent magnet rotor is connected with the output shaft of the DC drive motor, and the permanent magnet rotor rotates in the middle of the stator;

The stator fixed seat is provided with a plurality of first radial eccentric positioning holes and a plurality of first axial eccentric positioning holes, and the base is provided with a plurality of second radial eccentric positioning holes and a plurality of second axial positioning holes corresponding to the first radial eccentric positioning holes and the first axial eccentric positioning holes; the radial eccentricity setting of the stator and the stator winding is realized by fixing different first radial eccentric positioning holes and second radial eccentric positioning holes; and the axial eccentricity setting of the stator and the stator winding is realized by fixing different first axial eccentric positioning holes and second axial positioning holes;

A stator short circuit wiring board and a plurality of time relays, wherein the stator short circuit wiring board is provided with double-end connector lugs with different stator winding short circuit percentages, and the double-end connector lugs with different stator winding short circuit percentages are arranged and divided into a phase A, a phase B and a phase C; two double-end connector lugs between turns of any of the phase A, the phase B and the phase C are connected through one conducting wire, a connecting wire is led from the phase corresponding to the stator winding to form a short-circuited circuit, and one time relay is connected by the conducting wire to control on and off to realize the setting of static stator interturn short circuit faults; and two double-end connector lugs between different phases are connected through another conducting wire, a connecting wire is led from the phase corresponding to the stator winding to form a short-circuited circuit, and one time relay is connected by the conducting wire to control on and off to realize the setting of static stator interphase short circuit faults.

It can be known from the above technical solution that compared with the prior art, the present invention discloses and provides a permanent magnet generator experimental device for simulating electromechanical cross and complex faults, a certain degree of radial air-gap eccentricity is set by moving the stator and the stator winding, and then a stator short circuit is set by controlling the time relays; or a certain degree of axial air-gap eccentricity is set by moving a stator and a stator winding, and then a stator short circuit is set by controlling time relays. According to the above settings, different degrees of electromechanical cross and complex faults are simulated as required. The present invention is reliable in solution and easy to realize, and can simulate different degrees of radial air-gap eccentricity faults, axial air-gap eccentricity faults, stator short circuit faults, and compound faults of air-gap eccentricity and stator short circuit of a generator and provide the possibility of research and experimental analysis of air-gap eccentricity faults, stator short circuit faults, and compound faults of air-gap eccentricity and stator short circuit.

Further, the rotating shaft of the permanent magnet rotor is connected with the output shaft of the DC drive motor through a coupling.

Further, the plurality of first radial eccentric positioning holes and the plurality of second radial eccentric positioning holes are connected through a plurality of bolt-nut pairs, and the plurality of first axial eccentric positioning holes and the plurality of second axial positioning holes are connected through a plurality of bolt-nut pairs.

Further, the double-end connector lugs with different stator winding short circuit percentages of the phase A, the phase B and the phase C are arranged in three columns, and the winding short circuit percentages in each phase are set from small to large.

Further, the winding short circuit percentages in each phase are 0%, 3%, 6%, 9% and 12% in sequence.

Further, the stator fixed seat comprises a top flange seat and a bottom flange seat which are mutually buckled and fixed.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a stereogram of a permanent magnet generator experimental device for simulating electromechanical cross and complex faults provided by the present invention;

FIG. 2 is a front view of a permanent magnet generator experiment device for simulating electromechanical cross and complex faults;

FIG. 3 is a schematic diagram of matching of a stator fixed seat and a base;

FIG. 4 is an enlarged schematic diagram of part E in FIG. 3;

FIG. 5 is a structural schematic diagram of a permanent magnet generator;

FIG. 6 is a schematic diagram of positions of first radial eccentric positioning holes and first axial eccentric positioning holes at the bottom of a stator fixed seat;

FIG. 7 is a schematic diagram of positions of second radial eccentric positioning holes and second axial eccentric positioning holes in a base;

FIG. 8 is a schematic diagram of arrangement of a stator winding short circuit wiring board;

In the figures: 100—base, 101—second radial eccentric positioning hole, 102—second axial positioning hole, 200—DC drive motor, 201—DC drive motor base, 300—permanent magnet simulation generator, 301—stator, 3011—stator winding, 302—permanent magnet rotor, 303—stator fixed seat, 3031—first radial eccentric positioning hole, 3032—first axial eccentric positioning hole, 3033—top flange seat, 3034—bottom flange seat, 400—bearing seat, 500—stator short circuit wiring board, 501—double-end connector lug, 600—time relay, 700—coupling, and 800—bolt-nut pair.

### DETAILED DESCRIPTION

Embodiments of the present invention will be described below in detail. Examples of the embodiments are shown in drawings, wherein same or similar reference signs refer to same or similar elements or elements having same or similar functions from beginning to end. Embodiments described below by reference to the drawings are exemplary embodiments, and are used for explaining the present invention, and shall not be understood as a limitation to the present invention.

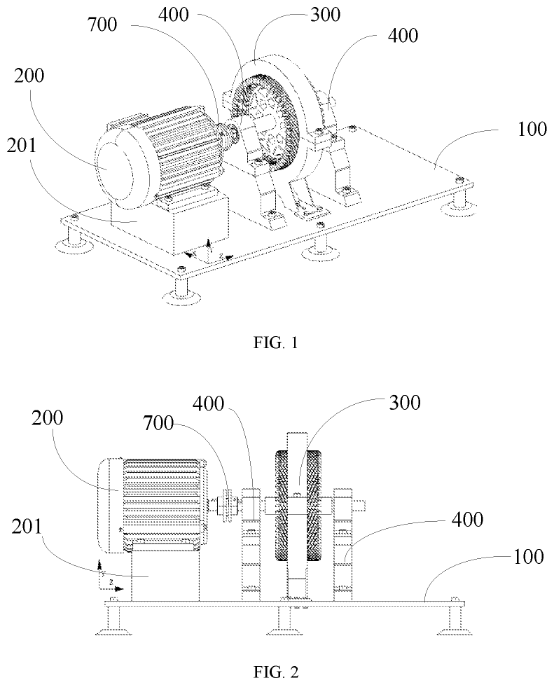

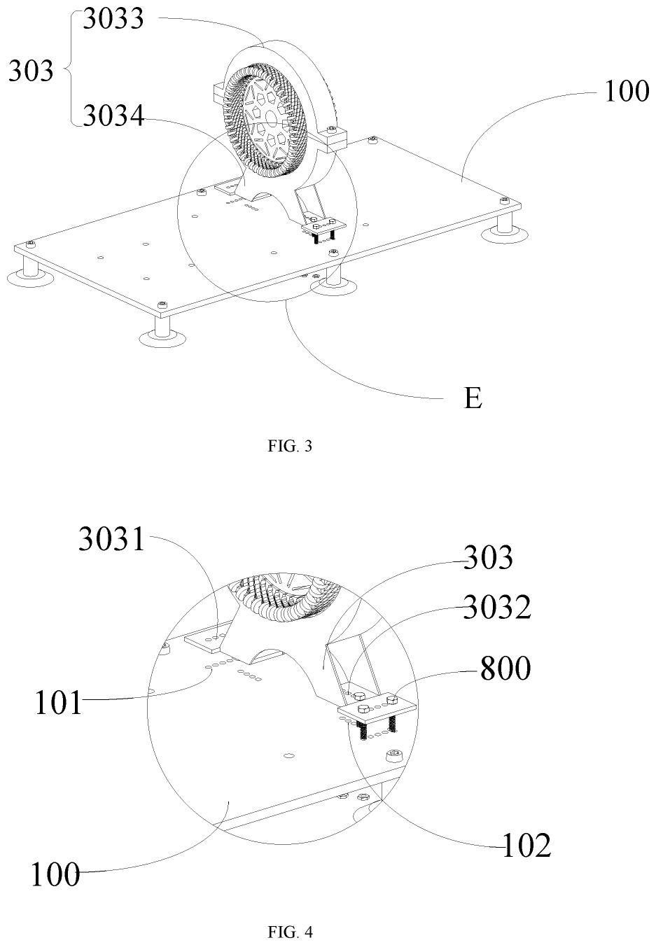

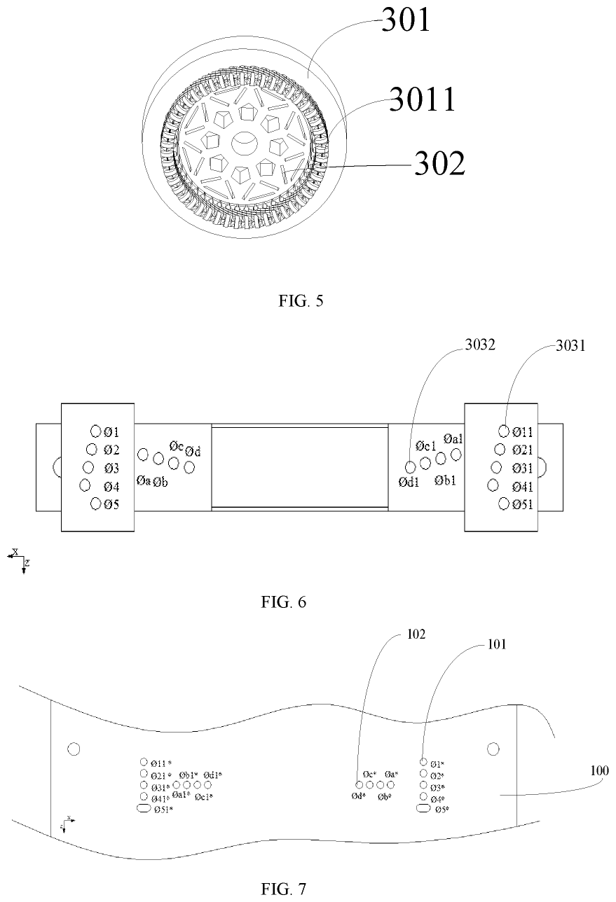

The embodiments of the present invention disclose a permanent magnet generator experimental device for simulating electromechanical cross and complex faults, as shown in FIG. 1-8, specifically comprising: a base 100, having a rectangular steel plate structure; a DC drive motor 200, fixed on the base 100 through a DC drive motor base 201; and a permanent magnet simulation generator 300, comprising a stator 301, a permanent magnet rotor 302 and a stator fixed seat 303, wherein the stator fixed seat 303 and the DC drive motor 200 are arranged in parallel on the base 100; the stator 301 is fixed in the stator fixed seat 303; and the permanent magnet rotor 302 is supported on the base 100 through two bearing seats 400, the rotating shaft of the permanent magnet rotor 302 is connected with the output shaft of the DC drive motor 200, and the permanent magnet rotor 302 rotates in the middle of the stator 301.

As shown in FIG. 6, the stator fixed seat 303 is provided with a plurality of first radial eccentric positioning holes 3031 and a plurality of first axial eccentric positioning holes 3032, the first radial eccentric positioning holes 3031 can be obliquely arranged along the X-axis direction, each first radial eccentric positioning hole is offset by a certain distance from the previous positioning hole, the first axial eccentric positioning holes 3032 can be obliquely arranged along the Z-axis direction, and each first axial eccentric positioning hole is offset by a certain distance from the previous positioning hole; as shown in FIG. 7, the base 100 is provided with a plurality of second radial eccentric positioning holes 101 and a plurality of second axial positioning holes 102 corresponding to the first radial eccentric positioning holes 3031 and the first axial eccentric positioning holes 3032; the second radial eccentric positioning holes 101 are arranged along the Z-axis direction, and the last positioning hole is a slotted hole; and the second axial positioning holes 102 are arranged along the direction.

The present invention realizes the radial eccentricity setting of the stator 301 and the stator winding 3011 by fixing different first radial eccentric positioning holes 3031 and second radial eccentric positioning holes 101; and realizes the axial eccentricity setting of the stator 301 and the stator winding 3011 by fixing different first axial eccentric positioning holes 3032 and second axial positioning holes 102.

A stator short circuit wiring board 500 and a plurality of time relays 600, wherein the stator short circuit wiring board 500 is provided with double-end connector lugs 501 with different stator winding short circuit percentages, and the double-end connector lugs 501 with different stator winding short circuit percentages are arranged and divided into a phase A, a phase B and a phase C; two double-end connector lugs 501 between turns of any of the phase A, the phase B and the phase C are connected through one conducting wire, a connecting wire is led from the phase corresponding to the stator winding 3011 to form a short-circuited circuit, and one time relay 600 is connected between the conducting wire to control on and off to realize the setting of static stator interturn short circuit faults; and two double-end connector lugs 501 between different phases are connected through another conducting wire, a connecting wire is led from the phase corresponding to the stator winding 3011 to form a short-circuited circuit, and one time relay 600 is connected by the conducting wire to control on and off to realize the setting of static stator interphase short circuit faults.

In the present invention, the base is fixed on the ground through anchor bolts.

The present invention can simulate different degrees of radial air-gap eccentricity faults; different degrees of axial air-gap eccentricity faults; different degrees of static stator short circuit faults; and different degrees of dynamic stator short circuit faults, so as to simulate multiple electromechanical compound faults through the combination of the four kinds of faults.

Advantageously, the rotating shaft of the permanent magnet rotor 302 is connected with the output shaft of the DC drive motor 200 through a coupling 700; and the plurality of first radial eccentric positioning holes 3031 and the plurality of second radial eccentric positioning holes 101 are connected through a plurality of bolt-nut pairs 800, and the plurality of first axial eccentric positioning holes 3032 and the plurality of second axial positioning holes 102 are connected through a plurality of bolt-nut pairs 800.

The double-end connector lugs 501 with different stator winding short circuit percentages of the phase A, the phase B and the phase C are arranged in three columns, and the winding short circuit percentages in each phase are set from small to large. Specifically, the winding short circuit percentages in each phase are 0%, 3%, 6%, 9% and 12% in sequence.

Advantageously, the stator fixed seat 303 comprises a top flange seat 3033 and a bottom flange seat 3034 which are mutually buckled and fixed.

As shown in FIG. 1-7, the present invention adopts the following method to simulate different degrees of radial air-gap static eccentricity faults: before radial static eccentricity is set, the DC drive motor 200, the permanent magnet simulation generator 300 and two bearing seats 400 are fixed on the base through bolts to form a whole without displacement in any form, which is regarded as the normal state of the device. The whole device realizes radial or axial eccentricity by changing the position of the stator fixed seat relative to the base to make the stator and the stator winding displace relatively to the rotor.

As shown in FIG. 6, a schematic diagram of the arrangement form of the positioning holes in the stator fixed seat is given, wherein the holes Φ1 and Φ11 in the stator fixed seat are positioning holes in the case of no radial eccentricity of the stator and the stator winding relative to the rotor, i.e., the position of normal operation of the generator; the positioning holes Φ1 and Φ11 are offset by 0.1 mm along the positive direction of the X axis in the case of no eccentricity of the positioning holes Φ2 and Φ21 in the stator fixed seat relative to the rotor; the positioning holes Φ1 and Φ11 are offset by 0.2 mm along the positive direction of the X axis in the case of no eccentricity of the positioning holes Φ3 and Φ31 in the stator fixed seat relative to the rotor; the positioning holes Φ1 and Φ11 are offset by 0.3 mm along the positive direction of the X axis in the case of no eccentricity of the positioning holes Φ4 and Φ41 in the stator fixed seat relative to the rotor; and four pairs of positioning holes Φ1-Φ11, Φ2-Φ21, Φ3-Φ31 and Φ4-Φ41 can respectively realize radial offset of the stator and the stator winding by 0 mm, 0.1 mm, 0.2 mm and 0.3 mm. However, Φ5-Φ51 are matched with the slotted holes Φ5* and Φ51* in the base, which does not affect radial free motion and only has an effect of auxiliary fixation during eccentricity setting. The positioning hole Φ1 in the stator fixed seat and the positioning hole Φ1* in the base are matched through a bolt-nut pair, the positioning hole Φ2 in the stator fixed seat and the positioning hole Φ2* in the base are matched through a bolt-nut pair, and the other positioning holes in the stator fixed seat and the other positioning holes in the base are matched in a similar way.

Φa, Φb, Φc, Φd, Φa1, Φb1, Φc1 and Φd1 are used for changing the axial eccentricity of the stator and the stator winding, wherein the holes Φd and Φd1 in the stator fixed seat are positioning holes in the case of no axial eccentricity of the stator and the stator winding relative to the rotor, i.e., the position of normal operation of the generator; the positioning holes Φd and Φd1 are offset by 0.1 mm along the negative direction of the Z axis in the case of no eccentricity of the positioning holes Φc and Φc1 in the stator fixed seat relative to the rotor; the positioning holes Φd and Φd1 are offset by 0.2 mm along the negative direction of the Z axis in the case of no eccentricity of the positioning holes Φb and Φb1 in the stator fixed seat relative to the rotor; the positioning holes Φd and Φd1 are offset by 0.3 mm along the negative direction of the Z axis in the case of no eccentricity of the positioning holes Φa and Φa1 in the stator fixed seat relative to the rotor; and four pairs of positioning holes Φd-Φd1, Φc-Φc1, Φb-Φb1 and Φa-Φa1 can respectively realize axial offset of the stator and the stator winding by 0 mm, 0.1 mm, 0.2 mm and 0.3 mm, the positioning hole Φa in the stator fixed seat and the positioning hole Φa1* in the base are matched through a bolt-nut pair, and the other positioning holes in the stator fixed seat and the other positioning holes in the base are matched in a similar way.

During eccentricity setting of the device, the change of radial eccentricity will not affect axial eccentricity, and similarly, the change of axial eccentricity will not affect radial eccentricity. Therefore, during radial eccentricity setting, it is necessary to take out the bolt-nut pair fixing axial eccentricity to ensure radial free motion, and during axial eccentricity setting, it is necessary to take out the bolt-nut pair fixing radial eccentricity to ensure axial free motion.

During radial eccentricity setting, it is necessary to take out the positioning bolt-nut pairs fixing axial eccentricity from the positioning holes Φd, Φd*, Φd1 and Φd1*, take out the bolt-nut pairs from the positioning holes Φ1, Φ1*, Φ11 and Φ11*, and loosen the bolt-nut pairs in the holes Φ5, Φ5*, Φ51 and Φ51*; and the bolts and nuts taken out are placed into the positioning holes Φ2, Φ2*, Φ21 and Φ21* again, the bolt-nut pairs in the positioning holes Φ2, Φ2*, Φ21 and Φ21* are re-tightened, then the bolt-nut pairs in the holes Φ5, Φ5*, Φ51 and Φ51* are re-tightened, and thus, the setting of radial eccentricity of 0.1 mm of the stator and the stator winding of the generator is completed. Similarly, the bolt-nut pairs are replaced to the positioning holes Φ3, Φ3*, Φ31 and Φ31* in sequence, and the positioning holes Φ4, (Φ4*, Φ41 and Φ41* can respectively realize radial eccentricity of 0.2 mm and 0.3 mm.

During axial eccentricity setting, it is necessary to loosen and take out the bolt-nut pairs fixing radial eccentricity from the positioning holes Φ1, Φ1*, Φ11 and Φ11* and the holes Φ5, Φ5*, 051 and Φ51* and loosen and take out the bolt-nut pairs from the positioning holes Φd, Φd*, Φd1 and Φd1*, the bolt-nut pairs taken out are placed into the positioning holes Φc, Φc*, Φc1 and Φc1* again, and then the bolt-nut pairs in the positioning holes Φc, Φc*, Φc1 and Φc1* are re-tightened. Thus, the setting of axial eccentricity of 0.1 mm of the stator and the stator winding of the generator is completed. Similarly, the bolt-nut pairs are replaced to the positioning holes Φb, Φb*, Φb1 and Φb1 in sequence, and the positioning holes Φa, Φa*, Φa1 and Φa1* can respectively realize axial eccentricity of 0.2 mm and 0.3 mm.

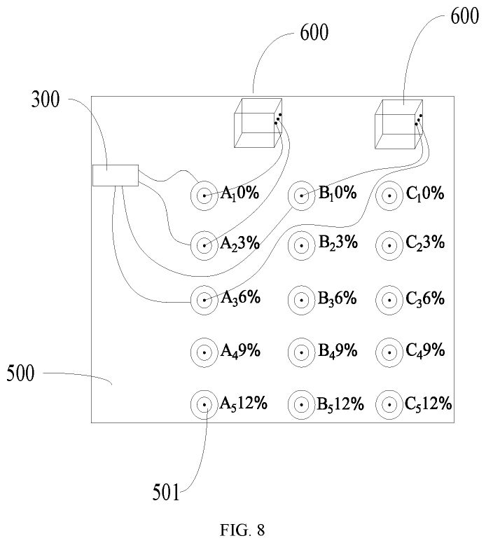

As shown in FIG. 1 and FIG. 8, the present invention adopts the following method to simulate different degrees of static stator short circuit faults:

For setting of different degrees of static stator short circuit faults, a stator short circuit wiring board as shown in FIG. 7 is arranged first, the stator winding short circuit percentage shall be set on the wiring board, and meanwhile, double-end connector lugs are arranged at A1, A2, A3, A4 and A5; and with the phase A as an example: part of the connecting wire of the stator winding of the phase A is connected to the double-end connector lug of one end of the stator short circuit wiring board, the stator winding with the short circuit degree corresponding to the short circuit percentage set on the stator short circuit wiring board is connected, and the connection modes of the phase B and the phase C are the same as that of the phase A. For setting of static stator interturn short circuit faults, with 3% stator interturn short circuit as an example, A1 and A2 are connected by a connecting wire through double-end connector lugs of A1 and A2, the closed circuit and the open circuit between A1 and A2 are controlled by one time relay, and after the DC drive motor drives the permanent magnet rotor to run stably through the coupling and the rotating shaft, the closed circuit between A1 and A2 is set through the time relay so that the stator winding of the generator has an interturn short circuit. A1 and A3 are connected through one time relay to simulate 6% stator interturn short circuit, A1 and A4 are connected to simulate 9% stator interturn short circuit, A1 and A5 are connected to simulate 12% stator interturn short circuit, and the setting of stator interturn short circuit of the other phases is similar to that of the phase A. For setting of static stator interphase short circuit faults, B1 and A3 are connected with one time relay in series by a connecting wire, the closed circuit and the open circuit between B1 and A3 are controlled by one time relay, and after the DC drive motor drives the permanent magnet rotor to run stably through the coupling and the rotating shaft, the closed circuit between B1 and A3 is controlled through the time relay so that the stator winding of the generator has an interphase short circuit. B1 and A2 are connected through one time relay to simulate 3% stator interphase short circuit, B1 and A4 are connected to simulate 9% stator interphase short circuit, B1 and A5 are connected to simulate 12% stator interphase short circuit, and the setting of stator interphase short circuit of the other phases is similar to that of the phases A and B. During the process of setting static stator short circuit, the time relay shall be adjusted after the permanent magnet rotor runs stably to maintain the on-state until the end of the experiment.

As shown in FIG. 1 and FIG. 8, the present invention adopts the following method to simulate different degrees of dynamic stator short circuit faults: For setting of different degrees of dynamic stator short circuit faults, the stator short circuit wiring board is also set, and the set short circuit percentage and the wiring setting are the same as those of the static stator short circuit. With 3% dynamic stator interturn short circuit of the phase A as an example, A1 and A2 are connected in series through one time relay and a connecting wire, and after the DC drive motor drives the permanent magnet rotor to run stably through the coupling and the rotating shaft, the quick switching of the closed circuit and the open circuit between A1 and A2 is controlled through the time relay so that the stator winding of the generator has a dynamic stator interturn short circuit. A1 and A3 are connected through one time relay to simulate 6% dynamic stator interturn short circuit, A1 and A4 are connected to simulate 9% dynamic stator interturn short circuit, A1 and A5 are connected to simulate 12% dynamic stator interturn short circuit, and the setting of dynamic stator interturn short circuit of the other phases is similar to that of the phase A. For setting of dynamic stator interphase short circuit faults, B1 and A3 are connected with one time relay in series by a connecting wire, the closed circuit and the open circuit between B1 and A3 are controlled by the time relay, and after the DC drive motor drives the permanent magnet rotor to run stably through the coupling and the rotating shaft, the closed circuit between B1 and A3 is controlled through the time relay so that the stator winding of the generator has an interphase short circuit. B1 and A2 are connected through one time relay to simulate 3% dynamic stator interphase short circuit, B1 and A4 are connected to simulate 9% dynamic stator interphase short circuit, B1 and A5 are connected to simulate 12% dynamic stator interphase short circuit, and the setting of dynamic stator interphase short circuit of the other phases is similar to that of the phases A and B. During the process of setting dynamic stator short circuit, the time relay shall be adjusted after the permanent magnet rotor runs stably to switch between the closed circuit and the open circuit. In order to be similar to the actual dynamic interturn short circuit, the switching frequency of the time relays shall be as low as possible.

Based on simulation of radial air-gap eccentricity faults, axial air-gap eccentricity faults, static stator short circuit faults and dynamic stator short circuit faults, the four kinds of faults can be combined to simulate multiple compound faults. For example, a certain degree of static stator short circuit can be set on the basis of setting a certain degree of radial air-gap eccentricity so as to simulate electromechanical compound faults of radial air-gap eccentricity and static stator short circuit; and a certain degree of dynamic stator short circuit can be set on the basis of setting a certain degree of axial air-gap eccentricity so as to simulate electromechanical compound faults of axial air-gap eccentricity and dynamic stator short circuit.

The present invention can simulate different degrees of radial air-gap eccentricity faults, axial air-gap eccentricity faults, static stator short circuit faults and dynamic stator short circuit faults, and meanwhile, simulate electromechanical cross faults formed by combining eccentricity and short circuit. The present invention can fill in the current gaps and deficiencies in simulation of air-gap eccentricity, stator interturn short circuit and electromechanical cross faults of a generator in the dynamic simulation experiment field, and lay a foundation for the experimental study of such faults.

In the illustration of this description, the illustration of reference terms “one embodiment”, “some embodiments”, “example”, “specific example” or “some examples”, etc. means that specific features, structures, materials or characteristics illustrated in combination with the embodiment or example are included in at least one embodiment or example of the present invention. In this description, exemplary statements for the above terms do not have to aim at the same embodiment or example. Moreover, the described specific features, structures, materials or characteristics can be combined appropriately in any one or more embodiments or examples. In addition, those skilled in the art can combine and integrate different embodiments or examples illustrated in this description.

Although the embodiments of the present invention have been shown and described above, it will be appreciated that the above embodiments are exemplary and shall not be understood as limitations to the present invention. Those ordinary skilled in the art can make changes, amendments, replacements and variations to the above embodiments within the scope of the present invention.

1. A permanent magnet generator experimental device for simulating electromechanical cross and complex faults, comprising:
a base (100), having a rectangular steel plate structure;
a DC drive motor (200), fixed on the base (100);
a permanent magnet simulation generator (300), comprising a stator (301), a permanent magnet rotor (302) and a stator fixed seat (303), wherein the stator fixed seat (303) and the DC drive motor (200) are arranged in parallel on the base (100); the stator (301) is fixed in the stator fixed seat (303); and the permanent magnet rotor (302) is supported on the base (100) through two bearing seats (400), the rotating shaft of the permanent magnet rotor (302) is connected with the output shaft of the DC drive motor (200), and the permanent magnet rotor (302) rotates in the middle of the stator (301);
wherein the stator fixed seat (303) is provided with a plurality of first radial eccentric positioning holes (3031) and a plurality of first axial eccentric positioning holes (3032), and the base (100) is provided with a plurality of second radial eccentric positioning holes (101) and a plurality of second axial positioning holes (102) corresponding to the first radial eccentric positioning holes (3031) and the first axial eccentric positioning holes (3032); the radial eccentricity setting of the stator (301) and the stator winding (3011) is realized by fixing different first radial eccentric positioning holes (3031) and second radial eccentric positioning holes (101); and the axial eccentricity setting of the stator (301) and the stator winding (3011) is realized by fixing different first axial eccentric positioning holes (3032) and second axial positioning holes (102);
a stator short circuit wiring board (500) and a plurality of time relays (600), wherein the stator short circuit wiring board (500) is provided with double-end connector lugs (501) with different stator winding short circuit percentages, and the double-end connector lugs (501) with different stator winding short circuit percentages are arranged and divided into a phase A, a phase B and a phase C; two double-end connector lugs (501) between turns of any of the phase A, the phase B and the phase C are connected through one conducting wire, a connecting wire is led from the phase corresponding to the stator winding (3011) to form a short-circuited circuit, and one time relay (600) is connected by the conducting wire to control on and off to realize the setting of static stator interturn short circuit faults; and two double-end connector lugs (501) between different phases are connected through another conducting wire, a connecting wire is led from the phase corresponding to the stator winding (3011) to form a short-circuited circuit, and one time relay (600) is connected by the conducting wire to control on and off to realize the setting of static stator interphase short circuit faults.

2. The permanent magnet generator experimental device for simulating electromechanical cross and complex faults according to claim 1, wherein the rotating shaft of the permanent magnet rotor (302) is connected with the output shaft of the DC drive motor (200) through a coupling (700).

3. The permanent magnet generator experimental device for simulating electromechanical cross and complex faults according to claim 1, wherein the plurality of first radial eccentric positioning holes (3031) and the plurality of second radial eccentric positioning holes (101) are connected through a plurality of bolt-nut pairs (800), and the plurality of first axial eccentric positioning holes (3032) and the plurality of second axial positioning holes (102) are connected through a plurality of bolt-nut pairs (800).

4. The permanent magnet generator experimental device for simulating electromechanical cross and complex faults according to claim 1, wherein the double-end connector lugs (501) with different stator winding short circuit percentages of the phase A, the phase B and the phase C are arranged in three columns, and the winding short circuit percentages in each phase are set from small to large.

5. The permanent magnet generator experimental device for simulating electromechanical cross and complex faults according to claim 4, wherein the winding short circuit percentages in each phase are 0%, 3%, 6%, 9% and 12% in sequence.

6. The permanent magnet generator experimental device for simulating electromechanical cross and complex faults according to any of claim 1, wherein the stator fixed seat (303) comprises a top flange seat (3033) and a bottom flange seat (3034) which are mutually buckled and fixed.
